(19) United States
(12) Patent Application Publication
(10) Pub. No.: US 2006/0124817 A1
(43) Pub. Date: Jun. 15, 2006

(54) Support for flower display

(76) Inventor: Philip White, North York (CA)

Correspondence Address: MANELLI DENISON & SELTER, 2000 M STREET NW SUITE 700, WASHINGTON, DC, 20036-3307, US

(21) Appl. No.: 11/299,623

(22) Filed: Dec. 13, 2005

(30) Foreign Application Priority Data
Dec. 15, 2004 (CA) 2,490,224

(51) Int. Cl. B42F 13/00

(52) U.S. Cl. 248/339

(57) ABSTRACT

A support for supporting an object and of use with a vertically, upstanding member, the support comprising (i) a u-shaped member for operably embracing a portion of the upstanding member and having an elongate first arm and an elongate second arm, essentially parallel thereto, integrally formed one to the other at an interarm base portion, and defining an interarm distance and an interarm plane; and the first arm having a first arm terminal portion and the second arm having a second arm terminal portion; and wherein the interarm distance is such as to allow the u-shaped member to operably, suitably receive a portion of the vertically upstanding member, (ii) an elongate extension arm having (a) a first terminal portion integrally formed with and extending from the first arm at a joined portion thereof, whereby a downward force applied to the extension arm effects a turning motion on the joined portion and concomitant upward movement of the second arm; (b) a second terminal portion distal from the first terminal portion; and (c) an object retention means integral with the extension arm at or adjacent the second terminal portion. The object is preferably a flower pot and the upstanding member is a post or plank preferably of a fence. The support allows the ready positioning and/or removal of the flower pot adjacent the post or fence without the need for nails, screws, or other post damaging articles.

This invention relates to supports for retaining objects, particularly flowerpots hanging from a post, fence and the like; and to display assemblies comprising said supports.

### BACKGROUND OF THE INVENTION

At present, objects such as flower pots hanging from a post, fence or the like are retained to the post by direct contact with the post or fence by nails, screws or the like, or tied thereto by wire, string or rope. Alternative means for hanging the flowerpot comprises an extension support which extends out from the post and which is nailed, screwed or the like to the post or fence. However, use of such an extension support requires the effort and inconvenience of inserting the nails or screws at the desired location on the post as a, generally, ‘one-shot’ attempt. If the exact location of the nails or screws is, not obtained, removal and exact re-insertion may not be possible. Further, unsightly holes will remain after the support is removed. Yet further, there are often limited options available to readily relocate the floral display should plurality of flowerpots be used in the display.

There is, therefore, a need for a support for hanging a flower pot or the like from a post or fence, which is easy and convenient to install to the fence, can be readily adjusted and does not leave unsightly holes in the post or fence when the support is removed.

### SUMMARY OF THE INVENTION

It is an object of the present invention to provide a support for hanging objects, such as flower pots, from a fence, post or the like, which does not require fastening means, particularly, nails, screws, wire or string.

It is a further object to provide an assembly comprising the aforesaid support retaining said object on said post or fence.

It is a yet further object to provide a display assembly comprising said support retaining said object to said post or fence.

Accordingly, in one aspect the invention provides an object support for use with an essentially vertically, upstanding member said support comprising

(i) a u-shaped member for operably embracing a portion of said upstanding member and having an elongate first arm and an elongate second arm, essentially parallel thereto, integrally formed one to the other at an interarm base portion, and defining an interarm distance and an interarm plane; and said first arm having a first arm terminal portion and said second arm having a second arm terminal portion; and wherein said interarm distance is such as to allow said u-shaped member to operably, suitably, receive a portion of said upstanding member,

(ii) an elongate extension arm having (a) a first terminal portion integrally formed with and extending from said first arm at a joined portion thereof, whereby a downward force applied to said extension arm effects a turning motion on said joined portion and concomitant upward movement of said second arm; (b) a second terminal portion distal from said first terminal portion; and (c) an object retention means integral with said extension arm at or adjacent said second terminal portion.

The upstanding member has a first or front face and a second or rear face and, thus, when the downward force applied to the extension arm by, for example, the weight of the motion on the joined portion, the upward movement of the second arm causes this arm to retainably abut the rear face of the upstanding member, and the downward movement of the first arm to retainably abut the front face of the upstanding member.

Most preferably, the extension arm defines a downward acute angle to the interarm plane and when the interarm plane is aligned vertically and the first arm is below the second arm.

Preferably, the first or lower arm, which is used below the upper or second arm, is selected to be about 40-70% of the length of the upper arm. This provides in use, where the length of the upper arm extends a little way beyond the width of the rectangular, upstanding member for example a post or wooden plank of a fence, that the end of the lower arm abuts the approximate centre of the plank.

In alternative embodiments the support as hereinabove defined comprises object retention means comprising an object-embracing member defining in whole or in part a horizontal aperture adapted to receive and retain said object.

Preferably, the object-embracing member defines an essentially circular aperture. The circle need not be fully completed but wherein the member has a sufficient length of circumference to retain the object.

In a preferred embodiment, the interarm distance at the approximately centre portion of the u-shaped member is less than the interarm distance adjacent the base portion. This results in the primary contact point of the lower arm being approximately central of the plank to provide minimum risk of unwanted, rotational pivotal movement of the support along the surface of the plank.

The essential feature of the support, as hereinabove defined, is the use of the weight of the object hanging from the distal end of the support to cause the u-shaped member to rotate in the vertical plane, until the upper arm abuts the rear surface of the plank, while the lower arm abuts the front surface of the plank, as the joined portion acts as a fulcrum in this action. The interarm distance and the downward acute angle are selected to provide that when the aforesaid action is effected, the extension arm is, preferably, essentially horizontal to the ground. These parameters are dependent on the thickness of the post or plank the u-shaped member is to embrace.

It can be seen that the support can be readily removed from the post by merely relieving the weight of the object from the support and sliding or lifting the support from the plank or post. The embracing operation of the support with the plank can be repeated at any suitable, desired location on the plank. Thus, no nails, screws, wire or other fastening means are needed.

The support may be made, for example, of any suitable metal or plastics material. The support may be of any suitable shape effective to retain the parallel arms thereto in the manner hereinbefore described. Thus, the vertical support in operation has preferably, a horizontal cross-section selected from a rectangle, oval and circle.

Thus, in a further aspect, the invention provides a support wherein said object retention means comprises an object-suspending portion.

In a further embodiment, the invention provides a support wherein said object-suspending portion comprises a portion selected from the group consisting of a vertically-aligned recess and aperture.

In a further embodiment, the invention provides a support wherein said object retention means comprises an object-embracing member defining in whole or in part a horizontal aperture adapted to receive and retain said object.

Preferably, the object-embracing member defines an essentially circular aperture.

In alternative embodiments, the object retention means comprises a support wherein said object retention means comprises a planar support member upon which said object is supported.

The support as hereinabove defined is of use with a support wherein said vertically, upstanding member has a horizontal cross-section selected from a rectangle, square, oval and circle.

In a further aspect, the invention provides an assembly comprising, in combination, a support, a rectangular, vertically upstanding member, and an object.

The support is preferably formed of a plastics material coated metal, the upstanding member of wood, typically a plank or post of wood of a garden fence.

The garden fence may comprise a plurality of the assemblies as hereinbefore defined.

In a further aspect, the invention provides a display stand provided with one or more assemblies as hereinbefore defined, of use in, for example, a retail store or garden centre.

### BRIEF DESCRIPTION OF THE DRAWINGS

In order that the invention may be better understood, the invention will now be described, by way of example only, with reference to the accompanying drawings, wherein

FIG. 1 is a diagrammatic, perspective view of an assembly according to the present invention;

FIG. 2 is a diagrammatic vertical elevation of an assembly according to the invention;

FIGS. 3 and 4 are perspective views of a support according to the invention;

FIG. 5 is a diagrammatic, perspective view of a display stand according to the invention;

FIG. 6 is a diagrammatic, horizontal sectional view along line b-b′ of FIG. 1;

FIG. 7 is a diagrammatic vertical view of a support, prior to embracement with a plank, according to the invention;

FIG. 8 is a diagrammatic perspective view of an alternative support comprising a ring object retention means according to the invention;

FIG. 9 is a diagrammatic vertical side view of the support of FIG. 8 retaining a flower pot;

FIG. 10 is a diagrammatic perspective view of an alternative support comprising a horizontal planar object retention means according to the invention;

FIG. 11 is a diagrammatic perspective view of an alternative support, in part, according to the invention for use with a square cross-sectional upstanding member;

FIG. 12 is a diagrammatic perspective view of an alternative support according to the invention;

FIG. 13 is a diagrammatic perspective view of a pair of supports according to the invention used in conjunction to support rather than suspend an object;

FIG. 14 is a diagrammatic vertical side view of a support according to the invention supporting an object;

FIGS. 15-18 represent horizontal sectional views of various supports according to the invention;

FIGS. 19A and 19B show perspective views of supports, in part, according to the invention, of use with various shaped vertical upstanding members; and wherein the same numerals denote like parts;

### DETAILED DESCRIPTION OF PREFERRED EMBODIMENTS

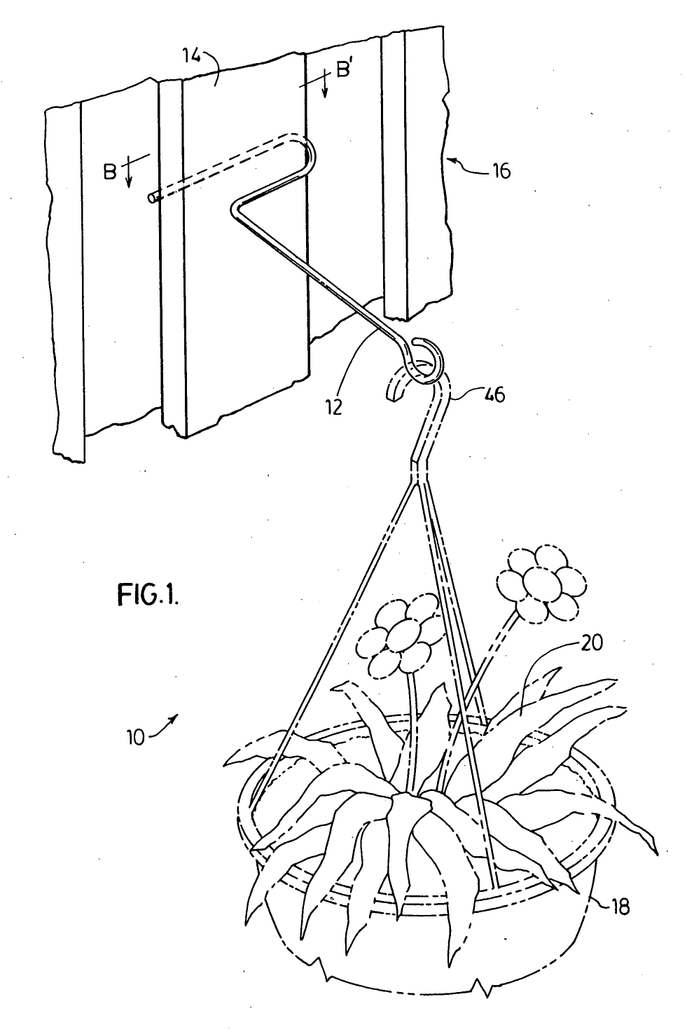

With reference to FIG. 1, this shows generally as 10, an assembly comprising a steel support 12 retained to a plank of wood 14 of a fence 16 (in part), and a flowerpot 18 containing flowers 20.

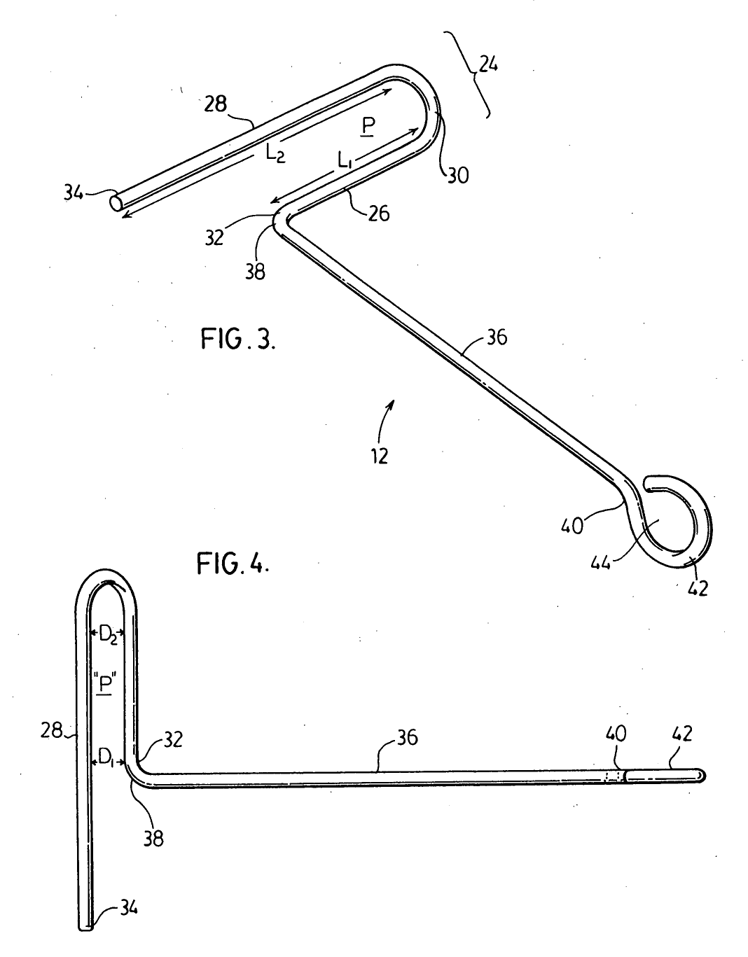

With reference to FIGS. 3 and 4, these show, in more detail, integrally formed support 12 having at one end u-shaped 24 having an elongate arm 26 essentially parallel to elongate arm 28 and formed therewith at interarm base portion 30. Arm 26 has a terminal portion 32 and arm 28 has a terminal portion 34 which, with portion 30, define an interarm plane “p”. Arm 26 has a length approximately 65% of the length L₂ of arm 28, from base portion 30.

Although essentially parallel, in this preferred embodiment, unshaped member 24 has an interarm distance D₁ at terminal portion 32 which D₁ is slightly smaller than interarm distance D₂ adjacent base portion 30 to constitute a slight widening of the interarm gap from terminal portion 32 to base portion 30 for reasons explained, hereinafter.

Member 24 at terminal portion 32 is integrally formed with elongate extension arm 36 at end 38 thereof. Arm 36 at its end 40 distal to end 38 has an eye member 42 having an aperture 44 for holding flower holder 18 by hook 46.

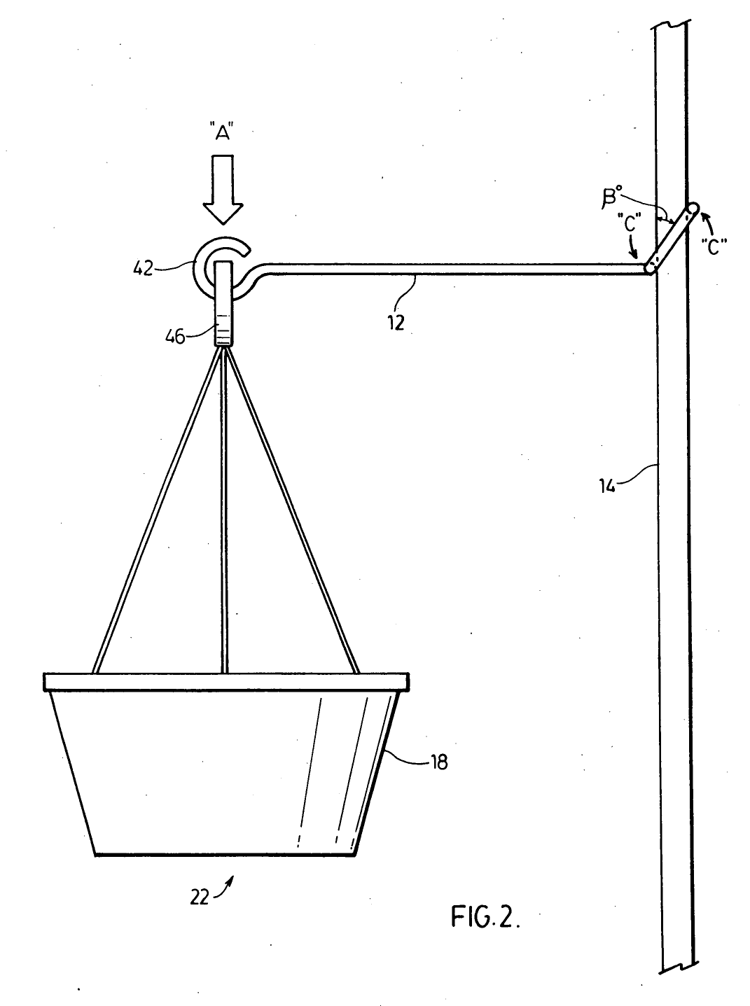

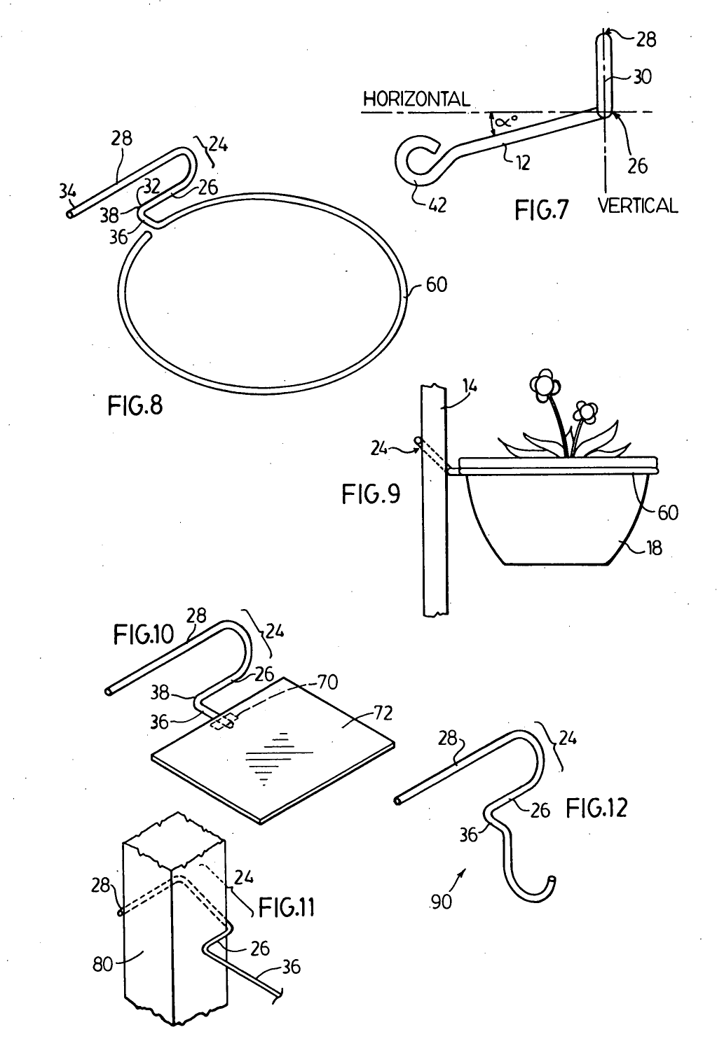

A rim 36 extends perpendicularly from arm 26 at portions 38, 32, in the horizontal plane when viewed from above as denoted by arrow “A” in FIG. 2; and FIG. 4. When viewed as a side elevation, in FIG. 7, extension arm 12 defines a downward acute angle “α” of about 45° from the horizontal plane to interarm plane “P” when interarm “P” is vertically and arm 26 is below arm 28.

With reference to FIG. 2, when arm 36 in horizontally aligned, with arm 26 below arm 28, plane “P” is aligned at “β” from the vertical plane, wherein β° is about 45° in the embodiment shown.

FIG. 5 shows a display stand, generally as 50, according to the invention, displaying a plurality of supports 12 on wood planks 14 supported by base 54.

In operation, support 12 having a suitable interarm distance D₁ is selected to allow entry of plank 14 of appropriate thickness, which entry is carried out when arm 36 is pointing upwardly while support 12 embraces plank 14 between arms 26, 28. Thus, plane “P” is aligned horizontally during the insertion movement. However, when sufficient weight is applied to support 12 at eye look 42, as arm 36 angles downwardly, arm 28 rotates through the vertical plane until it abuts and remains in frictional engagement with plank 14. This is best seen in FIG. 2, wherein arrows “C” show this rotational movement with terminal portions 32, 38 acting as a fulcrum to effect retaining engagement of portions 32, 38 and arm 28 with plank 14. It can be seen that the heavier the load at terminal portion 40, the greater the engagement of support. 12 with plank 14.

It will be recognized that selection of support 12 having a desired interarm distance will depend on the thickness of plank 14.

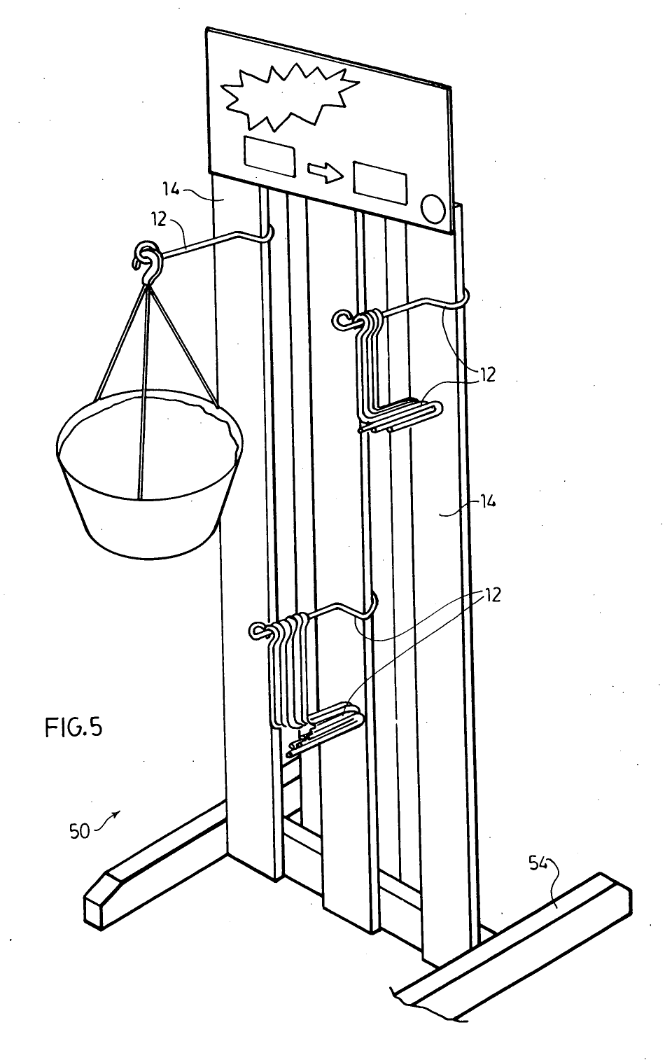

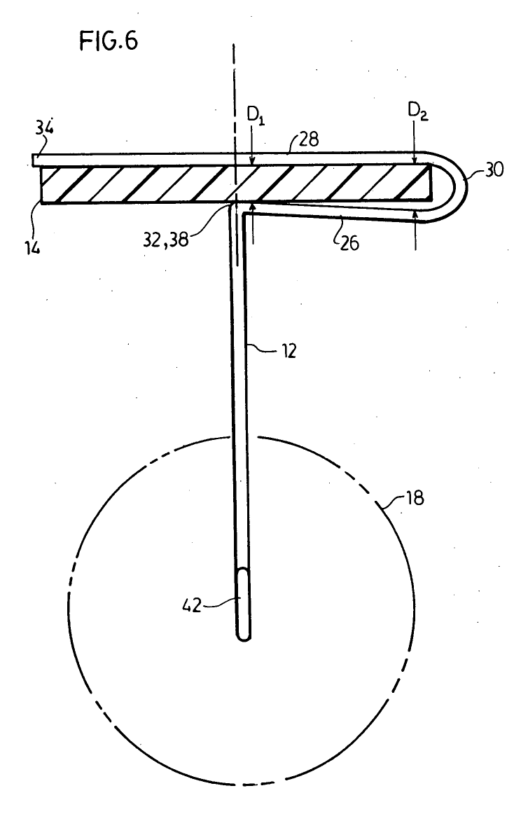

In a preferred embodiment shown with reference to FIG. 6, that although arms 26 and 28 are essentially parallel, there is a slight gradual widening of the interarm distance D₁ to that of D₂.

I have found that the optimum efficacy of the invention to reduce slippage of support 12 on plank 14 requires that portion 32, 38 be the prime contact point of arm 26.

Further, preferably, location of portion 32, 38 as a terminal portion of arm 26 having a length selected from about 40-70% of the length of arm 28 as shown in FIGS. 1, 3, 4 and 6, provides maximum efficacy of non-displaceable contact of support 12 and plank 14, by reason of reduced risk of vertical rotation of arms 26, 28 across the front and rear surfaces of plank 14 as to tip arms 26, 28 through uneven weighting on arm 26.

In alternative embodiments as shown in FIGS. 8 and 9, extension arm 36 at end 38 is integrally formed with a ring member 60 which wholly or in a significant part defines a circle or part thereof within which is operably received the object to be retained. In this embodiment, arm 36 is of any desired and suitable length. The ring member 60 constitutes the second terminal portion distal from the first terminal portion and the ring member, in effect also constitutes the object retention means.

FIG. 10 has the aforesaid described u-shaped member 24 and elongate extension arm 36 to which is affixed by embracing member 70 a planar object supporting member 72 formed of a suitable material, such as wood or a metal. Member 70 allows of support of a non-rounded object by other than the suspension hook 42 of other embodiments of the invention.

FIG. 11 demonstrates an alternative thickness of a vertical upstanding member 80 having a square, horizontal cross-section.

FIG. 12 illustrates a support 90 having a much smaller length of extension arm 36;

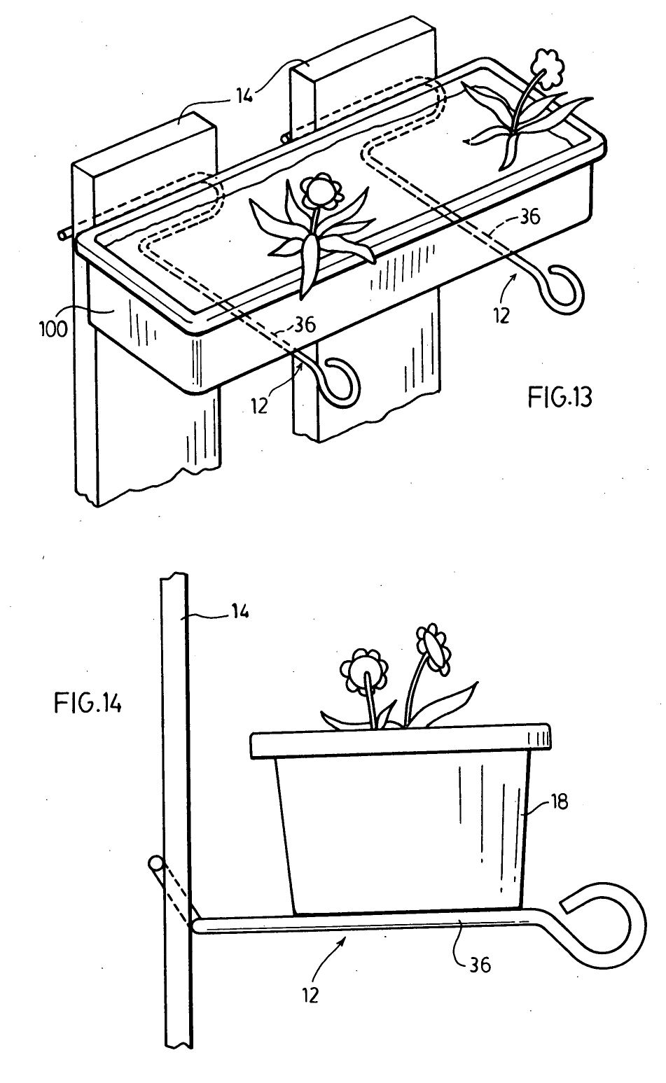

FIG. 13 illustrates use of a pair of supports 12 used in conjunction to support a common rectangular flowerpot 100 along two planks 14 of a wooden fence on elongate members 36.

FIG. 14 illustrates support, rather than suspension by elongate member 36 of a flowerpot 18 of support 12.

FIGS. 15-17 show alternative embodiments of u-shaped members of the supports having elongate arms of different relative lengths, and wherein both are in full contact through their inner surfaces 107 with the surfaces 108 of upstanding member 14.

FIG. 15 has first arm 110 and second arm 112 of equal length, and terminating essentially midway 115 of member 14.

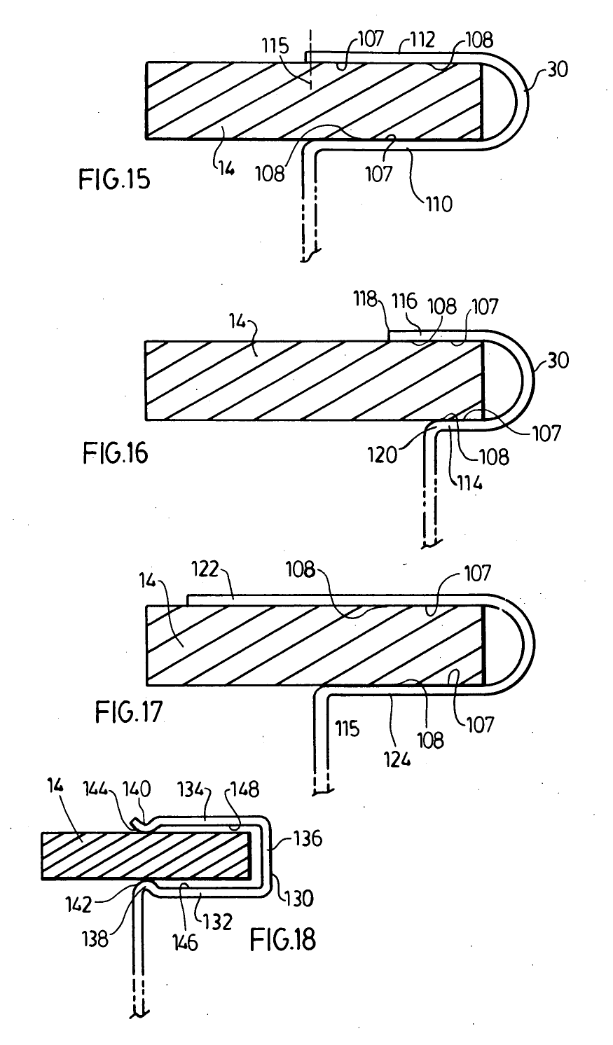

FIG. 16 has first arm 114 of a shorter length than second arm 116; and wherein both arms 114 and 116 terminate at 118, 120, respectively, closer adjacent base portion 30.

FIG. 17 has second arm 122 of greater length than first arm 124.

FIG. 18 illustrates a u-shaped member 130 having a first elongate arm 132 and a second elongate arm 134 of essentially equal length separated by an essentially perpendicular interarm base portion 136. Terminal arm portions 138, 140 respectively have inner arm protrusions 142, 144, respectively, which abut upstanding member 14, when operable abut upstanding member 14 according to the principle of the invention as hereinbefore described.

The remaining inner surfaces 146, 148 of arms 132 and 134, respectively, do not abut member 14. In alternative embodiments, inner arm protrusions may be suitably located intermittent of the lengths of arms 132 and/or 134.

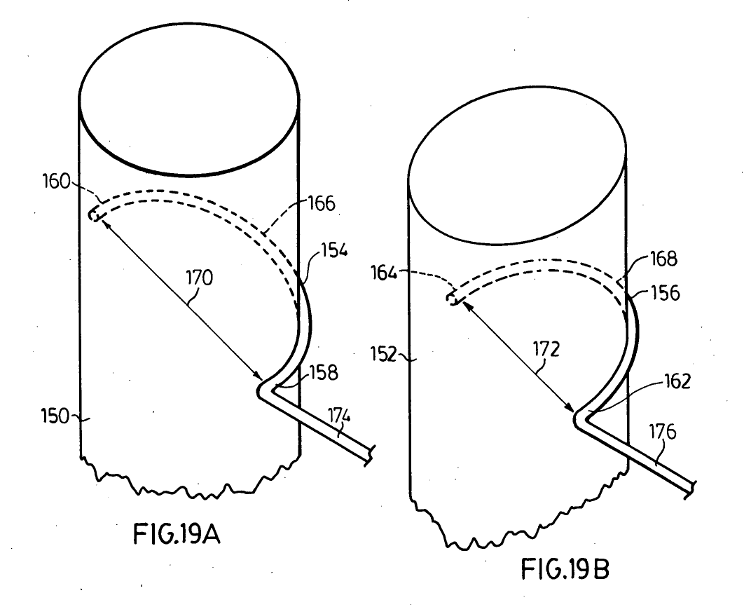

FIGS. 19A and 19B show round and oval in horizontal cross-section upstanding members 150 and 152, respectively, partially embraced by essentially complementary u-shaped members 154, 156, respectively. Members 154 and 156 incorporate the principle of the present invention constituted by elongate first and second members of suitable lengths, 158 and 160, respectively, and 162 and 164, respectively; a suitable interarm plane, base portions 166, 168, respectively, interarm distances 170, 172, respectively; and elongate extension arms 174, 176, respectively.

In further alternative embodiments, as shown in FIGS. 19A and 19B, the vertical upstanding member used with the object support may be a oval or round pole respectively, having a sufficient surface area to retentively abut sufficient areas of the elongate first and second arms of the u-shaped member as to operatively retain the object support on the vertically, upstanding member.

Thus, it can be seen that by judicious selection of support 12 of appropriate interarm distance, it can be located and retained on plank 14 without the need for nails, screws or other retaining means; and just as easily removed without leaving unsightly screw or nail holes. The invention further provides the opportunity for a plurality of flower pots and the like to be readily located and relocated, at will, as to readily provide the variation in a floral design along a fence or the like.

The support may be formed of any suitable material such as a metal or thermoplastics material.

The invention may be easily and readily shown as a display stand in garden products retail outlets and garden centres.

Although the invention has been illustrated herein with reference to a rectangular plank of wood, it should be understood that any suitably shaped object, rectangular or otherwise and for other utilities than as a flowerpot holder which incorporates the principle of the present invention is embraced by the present claims.

Although this disclosure has described and illustrated certain preferred embodiments of the invention, it is to be understood that the invention is not restricted to those particular embodiments. Rather, the invention includes all embodiments, which are functional or mechanical equivalence of the specific embodiments and features that have been described and illustrated.

1. A support for supporting an object and of use with a vertically, upstanding member, said support comprising
(i) a u-shaped member for operably embracing a portion of said upstanding member and having an elongate first arm and an elongate second arm, essentially parallel thereto, integrally formed one to the other at an interarm base portion, and defining an interarm distance and an interarm plane; and said first arm having a first arm terminal portion and said second arm having a second arm terminal portion; and wherein said interarm distance is such as to allow said u-shaped member to operably, suitably, receive a portion of said upstanding member,
(ii) an elongate extension arm having (a) a first terminal portion integrally formed with and extending from said first arm at a joined portion thereof, whereby a downward force applied to said extension arm effects a turning motion on said joined portion and concomitant upward movement of said second arm; (b) a second terminal portion distal from said first terminal portion; and (c) an object retention means integral with said extension arm at or adjacent said second terminal portion.

2. A support as claimed in claim 1 wherein said extension arm defines a downward acute angle to said interarm plane and when said interarm plane is aligned vertically and said first arm is below said second arm.

3. A support as claimed in claim 1 wherein said first arm is of a length selected from 40-70% of the length of said second arm.

4. A support as claimed in claim 1 wherein said joined portion is opposed midway of said second arm.

5. A support as claimed in claim 1 wherein said joined portion at or adjacent said first arm terminal portion.

6. A support as claimed in claim 1 wherein said downward acute angle is selected from 25-65°.

7. A support as claimed in claim 1 wherein the interarm distance at said joined portion is less than the interarm distance adjacent said base portion.

8. A support as claimed in claim 1 wherein said object retention means comprises an object-suspending portion.

9. A support as claimed in claim 8 wherein said object-suspending portion comprises a portion selected from the group consisting of a vertically-aligned recess and aperture.

10. A support as claimed in claim 1 wherein said object retention means comprises an object-embracing member defining in whole or in part a horizontal aperture adapted to receive and retain said object.

11. A support as claimed in claim 9 wherein said object-embracing member defines an essentially circular aperture.

12. A support as claimed in claim 1 wherein said object retention means comprises a planar support member upon which said object is supported.

13. A support as claimed in claim 1 wherein said vertically, upstanding member has a horizontal cross-section selected from a rectangle, square, oval and circle.

14. A support as claimed in claim 1 formed of a metal.

15. A support as claimed claim 1 formed of a plastics material.

16. A support as claimed in claim 1 wherein said vertically upstanding member is a plank of wood.

17. A support as claimed in claim 1 wherein said object comprises a flowerpot.

18. An assembly comprising, in combination, a support as claimed in claim 1, a vertically, upstanding member wherein said interarm distance is such as to allow said u-shaped member to operably, suitably, receive a portion of said vertically upstanding member, and an object.

19. An assembly as claimed in claim 18 wherein said support is formed of a metal, said upstanding member is formed of wood, and said object is a flower pot.

20. An assembly as claimed in claim 19 wherein said upstanding member is part of a garden fence.

21. A garden fence comprising an assembly as claimed in claim 18.

22. A garden fence comprising a plurality of assemblies as claimed in claim 18.

23. A display stand comprising as assembly as claimed in claim 18.

24. A display stand comprising a plurality of assemblies as claimed in claim 18.
